(19) United States
(12) Patent Application Publication
(10) Pub. No.: US 2006/0267476 A1
(43) Pub. Date: Nov. 30, 2006

(54) Electron emission device

(76) Inventors: Sang-Ho Jeon, Suwon-si (KR); Chun-Gyoo Lee, Suwon-si (KR); Sang-Jo Lee, Suwon-si (KR); Sang-Hyuck Ahn, Suwon-si (KR); Su-Bong Hong, Suwon-si (KR)

Correspondence Address: CHRISTIE, PARKER & HALE, LLP, PO BOX 7068, PASADENA, CA, 91109-7068, US

(21) Appl. No.: 11/351,552

(22) Filed: Feb. 10, 2006

(30) Foreign Application Priority Data
May 31, 2005 (KR) 10-2005-0046200

(51) Int. Cl. H01J 1/62; H01J 63/04; G09G 3/10

(52) U.S. Cl. 313/495; 313/497; 315/169.2

(57) ABSTRACT

An electron emission device includes electron emission regions formed on a first substrate, a driving electrode for controlling emission of electrons emitted from the electron emission regions, and a focusing electrode for focusing the electrons and having an opening through which the electrons pass. A first insulating layer is disposed between the driving electrode and the focusing electrode. The focusing electrode and the insulating layer satisfy at least one of the following two conditions: 1.0≦|Vf/t|≦6.0; and 0.2≦|Vf/Wh|≦0.4, where Vf (V) indicates the voltage applied to the focusing electrode, t (μm) indicates the thickness of the insulating layer, and Wh (μm) indicates the width of the opening of the focusing electrode.

### CROSS REFERENCE TO RELATED APPLICATION

This application claims priority to and the benefit of Korean Patent Application No. 10-2005-0046200 filed on May 31, 2005 in the Korean Intellectual Property Office, the entire content of which is incorporated herein by reference.

### BACKGROUND OF THE INVENTION

1. Field of the Invention

The present invention relates to an electron emission device, and in particular, to an electron emission device which has a focusing electrode placed over electron emission regions and driving electrodes to focus electron beams.

2. Description of Related Art

Generally, electron emission devices are classified into those using hot cathodes as an electron emission source, and those using cold cathodes as the electron emission source. There are several types of cold cathode electron emission devices, including a field emitter array (FEA) type, a metal-insulator-metal (MIM) type, a metal-insulator-semiconductor (MIS) type, and a surface conduction emitter (SCE) type.

The MIM-type and the MIS-type electron emission devices have electron emission regions with a metal/insulator/metal (MIM) structure and a metal/insulator/semiconductor (MIS) structure, respectively. When voltages are applied to the two metals or the metal and the semiconductor on respective sides of the insulator, electrons supplied by the metal or semiconductor on the lower side pass through the insulator due to the tunneling effect and arrive at the metal on the upper side. Of the electrons that arrive at the metal on the upper side, those that have energy greater than or equal to the work function of the metal on the upper side, are emitted from the upper electrode.

The SCE type electron emission device includes first and second electrodes formed on a substrate and facing each other, and a conductive thin film located between the first and the second electrodes. Micro-cracks are made in the conductive thin film to form electron emission regions. When voltages are applied to the electrodes while making an electric current flow to the surface of the conductive thin film, electrons are emitted from the electron emission regions.

The FEA type electron emission device is based on the principle that when a material having a low work function or a high aspect ratio is used as an electron emission source, electrons are easily emitted from the material due to the electric field in a vacuum atmosphere. A sharp-pointed tip structure based on molybdenum Mo or silicon Si, or a carbonaceous material, such as carbon nanotube has been developed to be used as electron emission regions.

Although the electron emission devices are differentiated in their specific structure depending upon the types thereof, they basically have first and second substrates sealed to each other to form a vacuum vessel, electron emission regions formed on the first substrate, driving electrodes for controlling the emission of electrons from the electron emission regions, phosphor layers formed on a surface of the second substrate facing the first substrate, and an anode electrode for accelerating the electrons emitted from the electron emission regions toward the phosphor layers, causing light emission or displaying to occur.

With the electron emission device, trials have been made to guide the trajectories of electron beams to the target direction and enhance the image quality. The electrons emitted from the first substrate frequently do not migrate straightly toward the second substrate, but are diffused so that they strike incorrect color phosphor layers neighboring the target color phosphor layer, and light-emit them.

It has been proposed that a focusing electrode should be provided to control the electron beams. The focusing electrode is placed at the topmost area of the first substrate while being insulated from the driving electrodes via an insulating layer. The focusing electrode has openings through which the electron beams pass. A negative direct current voltage of several to several tens of volts is applied to the focusing electrode such that a repulsive force is granted to the electrons passing the focusing electrode, and the electrons are focused to the center of the bundle of the electron beams.

With the operation of the electron emission device, the electric fields around the focusing electrode are varied depending upon the dimension of the voltage applied to the focusing electrode so that the bundle of electron beams reaching the second substrate have main beam components, and sub beam components external to the main beam components. The sub beam components have a diameter larger than that of the main beam components, but the intensity thereof is weaker than that of the main beam components.

Table 1 is a color coordinate of red, green and blue phosphor layers observed with the absence or presence of the sub beam component in the x and y directions, and the number in parenthesis is the difference of the color coordinate from the NTSC color coordinate.

TABLE 1

| | | | | | Color |
|---|---|---|---|---|---|
| | | Red | Green | Blue | reproducibility |
| Absence of | x | 0.615 | 0.285 | 0.151 | 63.8% |
| sub beam | | (0.055) | (−0.075) | (−0.011) | |
| component | y | 0.342 | 0.594 | 0.085 | |
| | | (−0.012) | (0.116) | (−0.005) | |
| Presence of | x | 0.545 | 0.295 | 0.153 | 41.4% |
| sub beam | | (0.125) | (−0.085) | (−0.013) | |
| component | y | 0.362 | 0.532 | 0.105 | |
| | | (−0.032) | (0.178) | (−0.025) | |
| NTSC color | x | 0.670 | 0.210 | 0.140 | — |
| coordinate | y | 0.330 | 0.710 | 0.080 | |

As can be seen from the Table 1, the color reproducibility is largely differentiated depending upon the presence or absence of the sub beam component. That is, the case with the presence of the sub beam component involves a color representation reduced by 22%, compared to the case with the absence of the sub beam component.

### SUMMARY OF THE INVENTION

In one exemplary embodiment of the present invention, there is provided an electron emission device which optimizes the relation between the structure of a focusing electrode and a focusing voltage to prevent the generation of sub beams and enhance the color purity.

In an exemplary embodiment of the present invention, an electron emission device includes electron emission regions formed on a first substrate, a driving electrode for controlling emission of the electrons emitted from the electron emission regions, and a focusing electrode for focusing the electrons has an opening through which the electrons pass. A first insulating layer is disposed between the driving electrode and the focusing electrode. The focusing electrode and the insulating layer satisfy at least one of the two following conditions: 1.0≦|Vf/t|≦6.0; and 0.2≦|Vf/Wh|≦0.4, where Vf (V) indicates the voltage applied to the focusing electrode, t (μm) indicates the thickness of the insulating layer, and Wh (μm) indicates the width of the opening of the focusing electrode.

The focusing electrode receives a negative voltage in one embodiment.

The electron emission regions may be arranged at pixel regions defined on the first substrate in a first direction, and the opening of the focusing electrode accommodates one or more of the electron emission regions. In one embodiment, the value of Wh may be measured in a direction perpendicular to the first direction.

The electron emission device may further include a second substrate facing the first substrate, and multi-colored phosphor layers formed on the second substrate. The colors of the respective phosphor layers can alternate in a direction perpendicular to the first direction.

An electron emission device can further include a cathode electrode formed on the first substrate, and a gate electrode formed on the first substrate and insulated from the cathode electrode by a second insulating layer formed between the cathode electrode and the gate electrode. The focusing electrode is over the gate and the cathode electrodes. Phosphor layers are formed on the second substrate. An anode electrode is formed on a surface of the phosphor layers.

The gate and the cathode electrodes may be disposed perpendicularly to each other and cross in a crossed region. The electron emission regions may also be linearly arranged along the length of the cathode electrode at the crossed region. The opening of the focusing electrode can accommodate the linearly arranged electron emission regions, and the value of Wh can be measured along the width of the cathode electrode.

Another embodiment of the invention is a focusing electrode for use in an electron emission device for focusing electron beams emitted from electron emission regions. The focusing electrode includes a plurality of openings disposed to accommodate the electron beams. Each opening has a width Wh. The focusing electrode is driven at a voltage Vf, and the relation of the width to the voltage satisfies the following condition: 0.2≦|Vf/Wh|≦0.4. The voltage Vf is negative in one embodiment.

In another embodiment of the invention, an electron emission device includes a first electrode disposed lengthwise in a first direction, a focusing electrode having an opening with a width Wh (μm) driven at a voltage Vf (V), and an insulating layer disposed between the driving electrode and the focusing electrode. The insulating layer has a thickness t (μm). The focusing electrode and the insulating layer can satisfy the following condition: 1.0≦|Vf/t|≦6.0.

The focusing electrode and the insulating layer can further satisfy the following condition: 0.2≦|Vf/Wh|≦0.4. The width Wh can also be measured in the first direction, and the voltage Vf can be negative. The first electrode can control emission of electron beams from a plurality of electron emission regions disposed along a direction perpendicular to the first direction. The opening can be sized to accommodate one or more of the electron beams emitted from the plurality of electron emission regions. The first electrode can be a cathode electrode or a driving electrode.

### BRIEF DESCRIPTION OF THE DRAWINGS

FIG. 1 is a partial exploded perspective view of an electron emission device according to an embodiment of the present invention.

FIG. 2 is a partial sectional view of the electron emission device according to the embodiment of FIG. 1.

FIG. 3 is a partial plan view of the structure on the first substrate shown in FIG. 1.

FIG. 4 is a partial sectional view of one embodiment of an electron emission unit according to the invention.

FIG. 5 is a partial sectional view of the second substrate and the light emission unit illustrating a variant of a light emission unit.

FIG. 6 is a graph illustrating the condition of |Vf/t|, where subsidiary light emission is not produced, as a function of the thickness of the second insulating layer with the electron emission device according to one embodiment of the present invention.

FIG. 7 is a graph illustrating the condition of |Vf/Wh|, where subsidiary light emission is not produced, as a function of the horizontal width of the focusing electrode opening according to an embodiment of the present invention.

FIG. 8 is a graph illustrating the relation between the value of |Vf/t| and color reproducibility for an embodiment of the present invention.

FIG. 9 is a graph illustrating the relation between the value of |Vf/Wh| and color reproducibility for another embodiment of the present invention.

### DETAILED DESCRIPTION

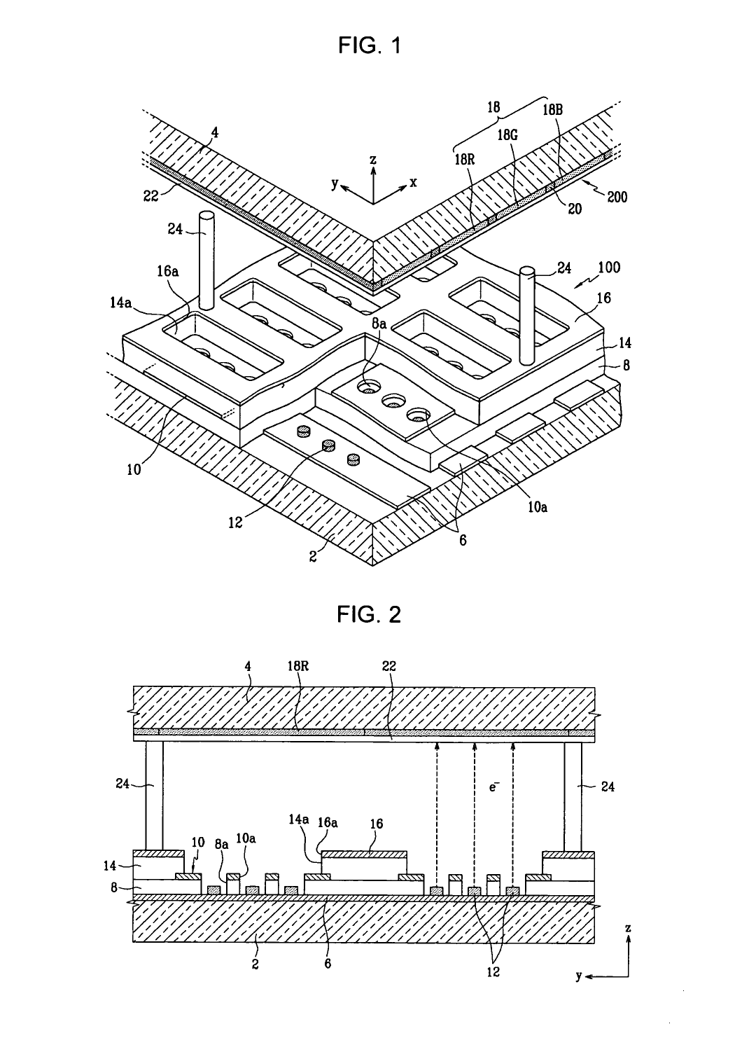

As shown in FIGS. 1 to 3, an electron emission device includes first and second substrates 2 and 4 arranged parallel to each other with a predetermined distance. A sealing member (not shown) is provided at the peripheries of the first and the second substrates 2 and 4, thereby forming a vacuum inner space in association with the two substrates. That is, the first and the second substrates 2 and 4, and the sealing member form a vacuum vessel.

An electron emission unit 100 is provided on a surface of the first substrate 2 facing the second substrate 4 to emit electrons toward the second substrate 4, and a light emission unit 200 is provided on a surface of the second substrate 4 facing the first substrate 2 to emit visible rays due to the electrons, thereby causing light emission or displaying to occur. In this embodiment, the structure of the electron emission unit and the light emission unit will be explained with a field emitter array (FEA) type electron emission device.

Cathode electrodes 6 are stripe-patterned on the first substrate 2, and a first insulating layer 8 covers substantially all of a surface of the first substrate 2. The first insulating layer also covers the cathode electrodes 6. Gate electrodes 10 are stripe-patterned on the first insulating layer 8 perpendicular to the cathode electrodes 6.

In this embodiment, when the crossed regions of the cathode and the gate electrodes 6 and 10 are defined as pixel regions, electron emission regions 12 are formed on the cathode electrodes 6 at the respective pixel regions, and openings 8a and 10a are formed at the first insulating layer 8 and the gate electrodes 10 corresponding to the respective electron emission regions 12 to expose the electron emission regions 12 on the cathode electrodes 6 on the first substrate 2.

The electron emission regions 12 are formed with a material emitting electrons under the application of an electric field in the vacuum atmosphere, such as a carbonaceous material, or a nanometer-sized material. The electron emission regions 12 may be formed with carbon nanotube, graphite, graphite nanofiber, diamond, diamond-like carbon, C₆₀, silicon nanowire or a suitable combination thereof, by way of, for example, screen-printing, direct growth, chemical vapor deposition, or sputtering.

In this embodiment, the electron emission regions 12 have a circular shape when viewed from a plan view, and a plurality of electron emission regions 12 are arranged along the length of the cathode electrodes 6 in the pixel regions. However, the shape, number per pixel region and arrangement of the electron emission regions 12 are not limited to those illustrated, but may be altered in various manners.

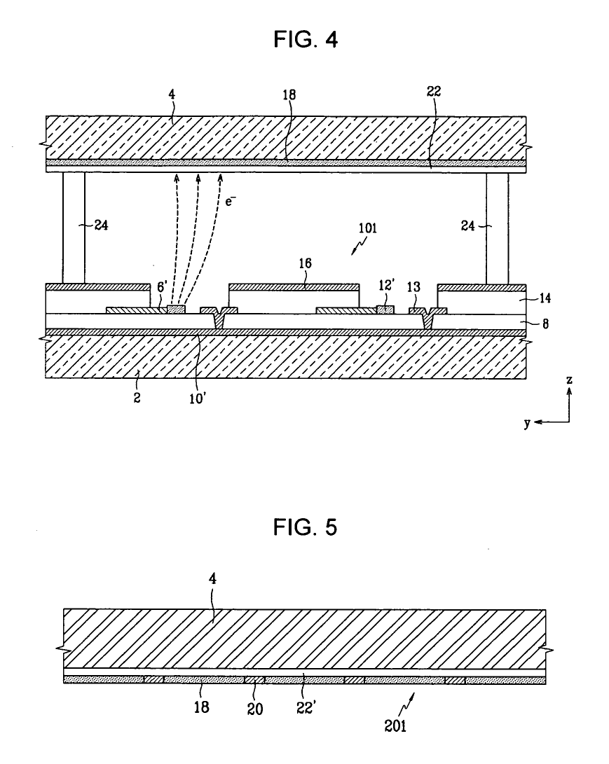

As shown in FIG. 4, the cathode and the gate electrodes 6′ and 10′ may be transposed. With the electron emission unit 101, the gate electrodes 10′ are placed under the cathode electrodes 6′ and a first insulating layer 8 is disposed between them. In this case, the electron emission regions 12′ may contact the lateral side of the cathode electrodes 6′ while being placed on the first insulating layer 8. Counter electrodes 13 are electrically connected to the gate electrodes 10′, and spaced apart from the electron emission regions 12′ between the cathode electrodes 6′. The counter electrodes 13 pull the electric fields of the gate electrodes 10′ over the first insulating layer 8 such that strong electric fields are formed around the electron emission regions 12′.

Referring back to FIGS. 1 to 3, a second insulating layer 14 and a focusing electrode 16 are formed on the gate electrodes 10 and the first insulating layer 8. Openings 14a and 16a are formed at the second insulating layer 14 and the focusing electrodes 16 to pass the electron beams. The openings 14a and 16a may be provided with a one-to-one correspondence at the respective pixel regions, and with this structure, the focusing electrode 16 collectively focuses the electrons emitted at the pixel region.

The greater the height difference between the focusing electrode 16 and the electron emission region 12 is, the greater the focusing effect becomes. Accordingly, the thickness of the second insulating layer 14 may be larger than the thickness of the first insulating layer 8. The focusing electrode 16 may be formed with a conductive film coated on the second insulating layer 14, or a metallic plate with openings 16a.

Phosphor layers 18 are formed on a surface of the second substrate 4 facing the first substrate 2 together with black layers 20, which are disposed between the respective phosphor layers 18 to enhance the screen contrast. The phosphor layers 18 may be formed with red, green and blue phosphor layers 18R, 18G and 18B spaced apart from each other by a particular distance. It is illustrated in FIG. 1 that the phosphor layers 18 and the black layers 20 are stripe-patterned, but each phosphor layer 18 may be separately located at a respective pixel region in a one-to-one correspondence. In the latter case, the black layers 20 may also be formed at all the non-light emission regions except for the phosphor layers 18.

An anode electrode 22 is formed on the phosphor layers 18 and the black layers 20 with a metallic material, such as aluminum. The anode electrode 22 receives a high voltage required for accelerating the electron beams from the emission regions, and reflects visible rays radiated from the phosphor layers 18, thereby increasing the screen luminance.

Alternatively, as shown in FIG. 5, an anode electrode 22′ is first formed on a surface of the second substrate 4, and phosphor layers 18 and black layers 20 are formed on the anode electrode 22′. In this case, the anode electrode 22′ is formed with a transparent conductive material such as indium tin oxide (ITO) such that it can transmit the visible rays radiated from the phosphor layers 18. The reference numeral 201 of FIG. 5 refers to a light emission unit.

Referring back to FIGS. 1 to 3, a plurality of spacers 24 are disposed between the first and the second substrates 2 and 4 to maintain the distance between the first and the second substrates 2 and 4. The spacers 24 support the vacuum vessel to prevent it from being distorted and broken. The spacers 24 are located corresponding to the black layers 20 such that they do not occupy the area of the phosphor layers 18.

With the above structured electron emission device, in operation, predetermined voltages are applied to the cathode electrodes 6, the gate electrodes 10, the focusing electrode 16, and the anode electrode 22 from the outside. For instance, a scan driving voltage is applied to one of the cathode and the gate electrodes 6 and 10, and a data driving voltage is applied to the other electrode. A negative direct current (DC) voltage of several to several tens of volts is applied to the focusing electrode 16, and a positive DC voltage of several hundred to several thousand volts is applied to the anode electrode 22.

Accordingly, with the pixel regions where the voltage difference between the cathode and the gate electrodes 6 and 10 exceeds a threshold value, electric fields are formed around the electron emission regions 12, and electrons are emitted from the electron emission regions 12. The emitted electrons experience a repulsive force while passing the focusing electrode 16, and are focused to the center of the bundle of electron beams. The focused electrons are attracted by the high voltage applied to the anode electrode, and collide against the corresponding phosphor layers to thereby light-emit them.

The electron beam focusing operation of the focusing electrode 16 is varied depending upon the magnitude of the focusing voltage, the thickness of the second insulating layer 14 and the horizontal width of the opening 16a of the focusing electrode 16. Based on these points, with the electron emission device according to the present embodiment, the generation of sub beam components inducing the subsidiary light emission and an emission error caused by an excessive focusing voltage is prevented by optimizing the relation between the focusing voltage and the structure of the focusing electrode.

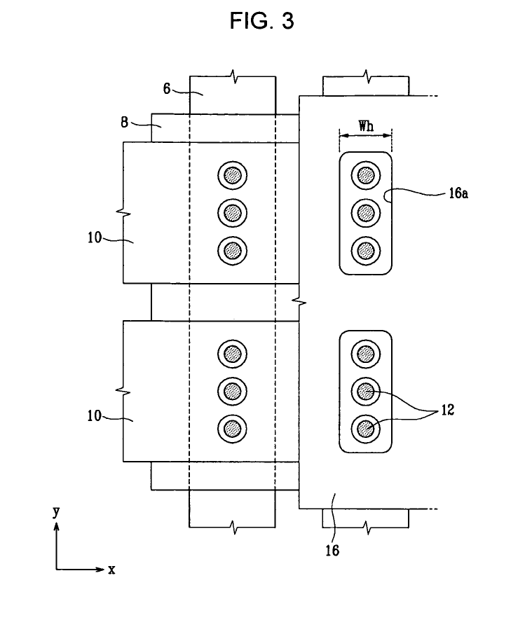

With the electron emission device according to this embodiment, the focusing electrode 16 and the second insulating layer 14 satisfy at least one of the two following conditions:
1.0≦|Vf/t|≦6.0 (Formula 1); and
0.2≦|Vf/Wh|≦0.4 (Formula 2),

where Vf (V) indicates the focusing voltage, t (μm) indicates the thickness of the second insulating layer 14 shown in FIG. 2, and Wh (μm) indicates the horizontal width of the focusing electrode opening 16a shown in FIG. 3.

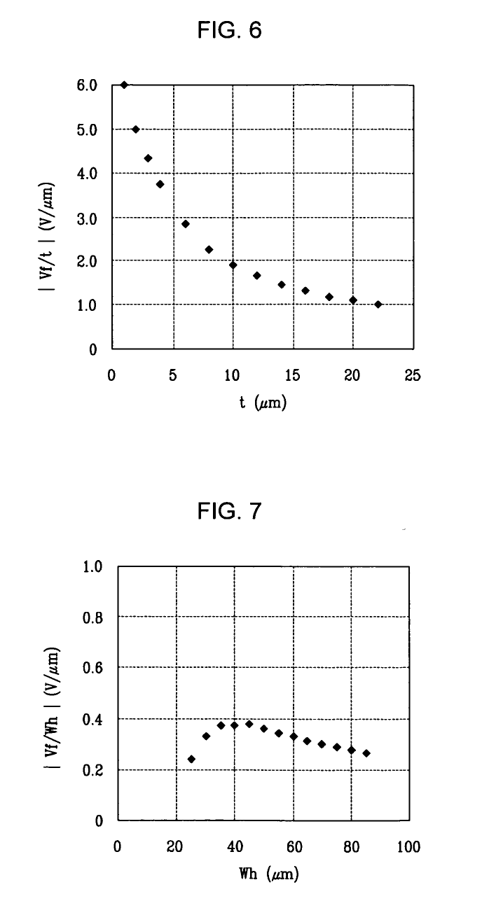

FIG. 6 is a graph illustrating the condition of |Vf/t| when subsidiary light emission was not produced. The thickness of the second insulating layer and the focusing voltage were varied. The thickness of the second insulating layer was varied from 0.2 μm to 25 μm. When the value of |Vf/t| ranged from 1V/μm to 6V/μm, subsidiary light emission was not produced.

In the case where the value of |Vf/t| was less than 1V/μm, the focusing voltage was too weak to focus the electrons in the above thickness range of the second insulating layer, thereby producing subsidiary light emission. In the case where the value of |Vf/t| exceeded 6V/μm, the focusing voltage was excessive in the above thickness range of the second insulating layer, thereby causing emission errors in which the electrons were emitted from off-state pixel regions.

FIG. 7 is a graph illustrating the condition of |Vf/Wh| where subsidiary light emission is not produced. The horizontal width of the focusing electrode opening and the focusing voltage were varied. The horizontal width of the focusing electrode opening was varied from 22 μm to 82 μm. In this horizontal width range, when the value of |Vf/Wh| was ranged from 0.2V/μm to 0.4V/μm, subsidiary light emission was not produced.

In the case where the value of |Vf/Wh| is less than 0.2V/μm, the focusing voltage was too weak to focus the electrons in the above width range of the focusing electrode opening, thereby producing subsidiary light emission. In the case where the value of |Vf/Wh| exceeded 0.4V/μm, the focusing voltage was excessive in the above width range, thereby causing emission errors in which the electrons were emitted from the off-state pixel regions.

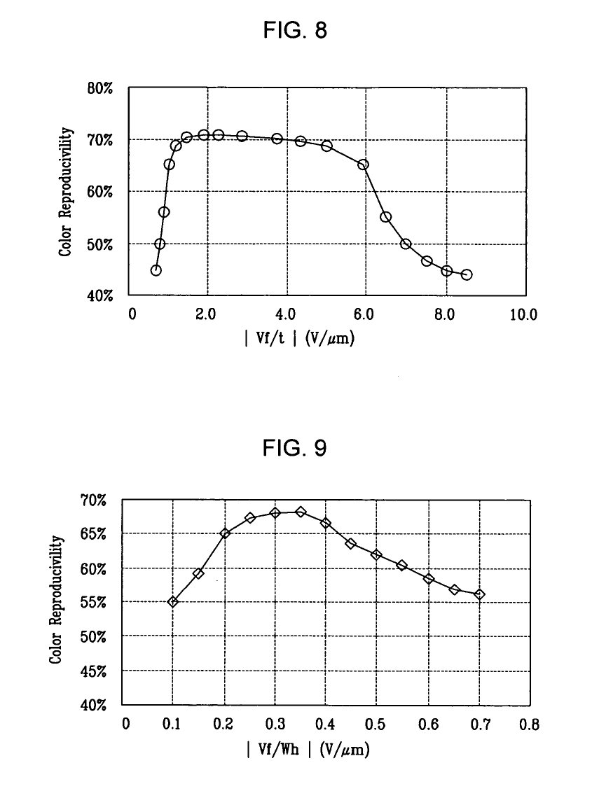

FIG. 8 is a graph illustrating a color reproducibility (compared to the NTSC) as a function of variation in |Vf/t| with an electron emission device satisfying the condition of the Formula 1. FIG. 9 is a graph illustrating a color reproducibility (also compared to the NTSC) as a function of variation in |Vf/Wh| with the electron emission device satisfying the condition of the Formula 2. As shown in FIGS. 8 and 9, when |Vf/t| is in the range of 1V/μm-6V/μm and |Vf/Wh| is in the range of 0.2V/μm-0.4V/μm, an excellent color reproducibility of 65% or more can be obtained.

In the above-described embodiments of an electron emission device and focusing electrode, the generation of sub beam components causing subsidiary light emission can be prevented by optimizing the relation between the focusing voltage and the structure of the focusing electrode. Consequently, the electrons emitted from the electron emission regions can land on the correct, corresponding phosphor layers. Thus, color representation of the phosphor layers and the image quality of the displayed image can be enhanced.

These features are described above in relation to an FEA type electron emission device, where the electron emission regions are formed with a material emitting electrons under the application of an electric field. However, the invention is not limited to an FEA type electron emission device, but may be easily applied to other types of electron emission devices.

Although exemplary embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims and their equivalents.

What is claimed is:

1. An electron emission device comprising:
electron emission regions formed on a first substrate;
a driving electrode for controlling electrons emitted from the electron emission regions;
a focusing electrode for focusing the electrons and having an opening through which the electrons pass; and
a first insulating layer disposed between the driving electrode and the focusing electrode;
wherein the focusing electrode and the first insulating layer satisfy at least one of the two following conditions:
1.0≦|Vf/t|≦6.0; and
0.2≦|Vf/Wh|≦0.4,
where Vf (V) indicates a voltage applied to the focusing electrode, t (μm) indicates a thickness of the first insulating layer, and Wh (μm) indicates a width of the opening of the focusing electrode.

2. The electron emission region of claim 1, wherein the focusing electrode receives a negative voltage.

3. The electron emission region of claim 1, wherein the electron emission regions are arranged at pixel regions defined on the first substrate along a first direction, and the opening of the focusing electrode accommodates one or more of the electron emission regions, and
wherein the width of the opening is measured in a direction perpendicular to the first direction.

4. The electron emission device of claim 3, further comprising multi-colored phosphor layers disposed on a second substrate facing the first substrate such that a color of each respective phosphor layer alternates along a direction perpendicular to the first direction.

5. The electron emission device of claim 1, further comprising:
a second substrate facing the first substrate and having phosphor layers formed thereon;
an anode electrode formed on a surface of the phosphor layers;
a cathode electrode formed on the first substrate; and
a gate electrode formed on the first substrate and insulated from the cathode electrode by a second insulating layer formed between the cathode electrode and the gate electrode.

6. The electron emission device of claim 5, wherein the gate electrode and the cathode electrode are disposed perpendicularly to each other and cross in a crossed region, and the electron emission regions are disposed linearly along a length of the cathode electrode at the crossed region.

7. The electron emission device of claim 6, wherein the opening of the focusing electrode is sized to accommodate one or more of the linearly arranged electron emission regions, and the width of the opening is measured along a direction perpendicular to the length of the cathode electrode.

8. The electron emission device of claim 7, wherein the phosphor layers are multi-colored, and a color of each respective phosphor layer alternates in a direction perpendicular to the length of the cathode electrode.

9. The electron emission device of claim 5, wherein the first insulating layer has a thickness greater than the second insulating layer.

10. The electron emission device of claim 5, wherein the electron emission regions comprise at least one material selected from the group consisting of carbon nanotube, graphite, graphite nanofiber, diamond, diamond-like carbon, C₆₀ and silicon nanowire.

11. A focusing electrode for use in an electron emission device for focusing an electron beam emitted from an electron emission region, the focusing electrode comprising an opening disposed to accommodate said electron beam, each opening having a width Wh (μm), wherein the focusing electrode is driven at a voltage Vf (V), and wherein the relation of the width to the voltage satisfies the following condition: 0.2≦|Vf/Wh|≦0.4.

12. The focusing electrode of claim 11, wherein the voltage Vf is negative.

13. An electron emission device comprising:
a first electrode disposed lengthwise in a first direction;
a focusing electrode having an opening with a width Wh (μm) driven at a voltage Vf;
an insulating layer disposed between the first electrode and the focusing electrode and having a thickness t (μm),
wherein the focusing electrode and the insulating layer satisfy the following condition: 1.0≦|Vf/t|≦6.0.

14. The electron emission device of claim 13, wherein the focusing electrode further satisfies the following condition: 0.2≦|Vf/Wh|≦0.4.

15. The electron emission device of claim 14, wherein the width Wh is measured in the first direction.

16. The electron emission device of claim 13, wherein the voltage Vf is negative.

17. The electron emission device of claim 13, wherein the first electrode controls emission of electron beams from a plurality of electron emission regions disposed in a direction perpendicular to the first direction, and wherein the opening is sized to accommodate electron beams emitted from one or more of the plurality of electron emission regions.

18. The electron emission device of claim 13, wherein the first electrode is a driving electrode.

19. The electron emission device of claim 13, wherein the first electrode is a cathode electrode.
